(19) United States
(12) Patent Application Publication
(10) Pub. No.: US 2022/0307970 A1
(43) Pub. Date: Sep. 29, 2022

(54) INTEGRATED CORROSION MONITORING ULTRASOUND PROBE AND PROBING LOCATION DETERMINATION METHOD AND DEVICE

(71) Applicant: SAUDI ARABIAN OIL COMPANY, Dhahran (SA)

(72) Inventors: Rami A. Alsulaim, Alkhobar (SA); Mohamed Attia, Dhahran (SA)

(73) Assignee: SAUDI ARABIAN OIL COMPANY, Dhahran (SA)

(21) Appl. No.: 17/212,420

(22) Filed: Mar. 25, 2021

(51) Int. Cl. G01N 17/04; G01B 17/02

(52) U.S. Cl. CPC G01N 17/04; G01B 17/02

(57) ABSTRACT

A portable corrosion monitoring device is described that includes at least one corrosion monitoring sensor, a wireless transceiver configured to receive signals from a plurality of remote wireless beacons, a microprocessor containing executable instructions to determine the spatial position of the portable corrosion monitoring device based, at least in part, on the signals received from the plurality of remote wireless beacons, and a visual display to communicate instructions to an operator of the portable corrosion monitoring device.

### BACKGROUND

Corrosion is a process that converts a refined metal into a more chemically stable form such as an oxide, hydroxide, or sulfide. It causes the gradual destruction of metals by chemical and/or electrochemical reaction with their environment. High-temperature corrosion is chemical deterioration of a material as a result of heating. This non-galvanic form of corrosion can occur when a metal is subjected to a hot atmosphere containing oxygen, sulfur, or other compounds capable of oxidizing, or facilitating the oxidation of, the material concerned.

The corrosion of industrial plant, particularly pressure vessels and piping carrying corrosive fluids or exposed to an external corrosive environment, can pose safety, health, environmental and economic risks. Consequently, corrosion monitoring is a routine task of paramount important routine task in the safe operation of industrial facilities, including oil and gas refineries, gas-oil separation plants, and chemical and petrochemical production plants.

Corrosion monitoring refers to the probing, observing and assessing of the change materials induced by breakdown processes such as atmospheric rusting, chemical solution, oxidation, crystallization, and galvanic coupling reactions. The change of a material that may be monitored includes the loss of thickness, loss of weight, or the alteration of physical, chemical, electrical, magnetic or mechanical properties. Corrosion monitoring is often implemented by repeating a specific corrosion “probing” technique at a plurality of specified locations under a predetermined regime of repeat intervals. Corrosion regression is determined by examining the change in the quantity probed over the repeated measurements, such as measurements of the thickness of the walls of metal components. For this approach to corrosion monitoring to be effective the corrosion monitoring locations (110) must be repeatable to a high degree of precision and probing measurements must be accurately and reliably associated with the probing location at which they were made. Traditional procedures for achieving repeatable and reliable identification of corrosion monitoring locations (110) include marking these locations on plant drawings and documentation. In addition, the locations may be indelibly marked, with paint or ink, on the equipment components themselves. The documentation of the probe readings has traditionally performed manually on paper, or electronically via manually operated keyboard, or both.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a portable corrosion monitoring device is described that includes at least one corrosion monitoring sensor, a wireless transceiver configured to receive signals from a plurality of remote wireless beacons, a microprocessor containing executable instructions to determine the spatial position of the portable corrosion monitoring device based, at least in part, on the signals received from the plurality of remote wireless beacons, and a visual display to communicate instructions to an operator of the portable corrosion monitoring device.

In general, in one aspect, embodiments relate to a portable corrosion monitoring system including a plurality of remote wireless beacons located at a plurality of different spatial locations and at least one corrosion monitoring device configured to wirelessly exchange a signal with the plurality of remote wireless beacons. Furthermore, the portable corrosion monitoring system determines at least one of a spatial position of the portable corrosion monitoring device and a spatial orientation of the portable corrosion monitoring device. The portable corrosion monitoring system further includes a computer system to receive and process corrosion monitoring measurements made by the corrosion monitoring device.

In general, in one aspect, embodiments relate to a method of corrosion monitoring including installing a plurality of wireless beacons at a plurality of different spatial locations configured to wirelessly communicate with a portable corrosion monitoring device and entering the coordinates of at least one predetermined corrosion monitoring location into a portable corrosion monitoring device that is in wireless communication with the plurality of remote wireless beacons. Further, the method of corrosion monitoring includes determining the current location of the portable corrosion monitoring device based, at least in part, on a wireless signal received from at least a portion of the plurality of the remote wireless beacons, positioning the portable corrosion monitoring device at the predetermined corrosion monitoring location, and performing a corrosion monitoring measurement of a sample.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a portable system in accordance with one or more embodiments.

FIG. 3 shows a portable system in accordance with one or more embodiments.

FIG. 4 shows a network in accordance with one or more embodiments.

FIG. 5 shows a network in accordance with one or more embodiments.

FIG. 6 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The embodiments disclosed herein describe an integrated device and method for making corrosion monitoring measurements at predetermined corrosion monitoring locations around an industrial facility, such as refineries, gas plants, and gas-oil separation plants. The device integrates a corrosion monitoring probe, such as an ultrasonic thickness tester, and a spatial location determination apparatus for determining the location of the integrated device. The spatial location determination apparatus may use wireless signals from a network of remote wireless beacons spatially distributed around the facility. The wireless signals may use the Bluetooth Low Energy standard for communication.

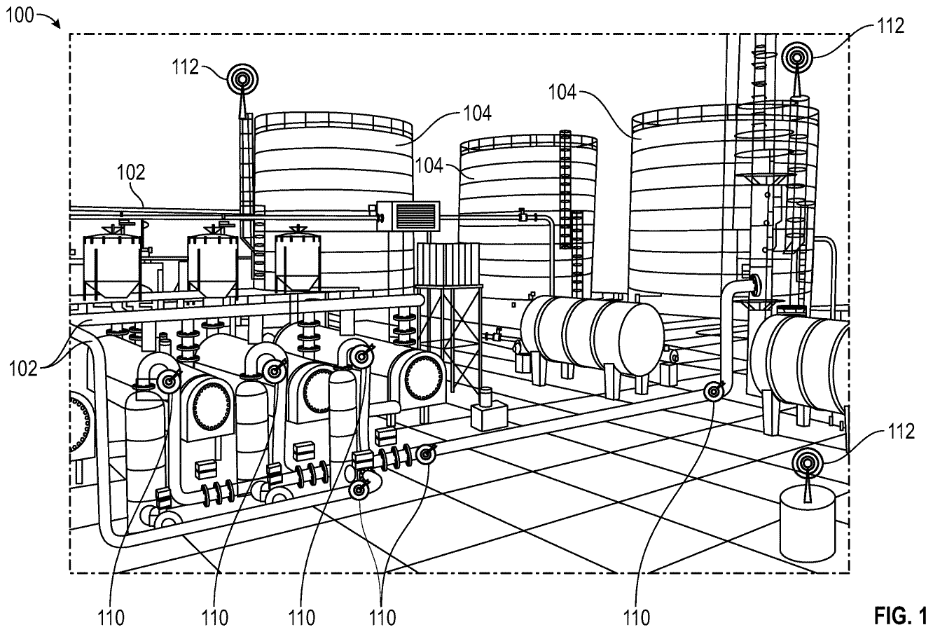

FIG. 1 shows an exemplary industrial facility (100), in accordance with one or more embodiments. The facility (100) may be a crude oil, a natural gas storage facility (100), or a gas-oil separation plant. In other embodiments, the facility (100) may be a hydrocarbon refinery or a chemical plant. Such facilities are characterized by a plurality of pipes (102), storage tanks (104), pressure vessels, valves, and connections. In some case, these components may be constructed from materials, or may be coated with finishes, designed to resist corrosion. However, despite these design precautions, corrosion monitoring protocols are routinely required to track the development of corrosion and provide forewarning of potential corrosion related failures of equipment by forecasting the remaining life based on the calculate corrosion rate.

A typical corrosion monitoring protocol may involve the identification of a set of corrosion monitoring locations (110). These corrosion monitoring locations (110) may be chosen to be a representative sampling of a large set of plant components or may be chosen because they are predicted to be site particularly prone or vulnerable to corrosion. These corrosion monitoring locations (110) should be selected based on the potential damage mechanisms and the design features of the equipment in addition to the experience with other similar facilities or sub-systems. Typically, there are ten thousand, or more, corrosion monitoring locations (110) within a single facility (100).

In accordance with one or more embodiments, a corrosion monitoring protocol may consist of returning repeatedly to each of the set of corrosion monitoring locations (110) and making at least one probing measurement. The time interval between repeat measurements may be a regular predetermined interval or may be a variable interval based, at least in part, on the previous recorded values and the limit state function of the equipment that define when the equipment can be safely operated. For example, if the most recent recorded value at a corrosion monitoring location (110) had changed significantly from previous values at the corrosion monitoring location (110) the next recording may be made after a shorter interval, normally half of the calculated remaining life.

The corrosion monitoring protocol may further include comparing the last recorded value of a corrosion probing measurement from a corrosion monitoring location (110) with at least one probing measurement with previously values from the same corrosion monitoring location (110). Changes, particularly large or rapid changes, in the value of the probing measurement made at the same corrosion monitoring location (110) at different times may indicate the presence of concerning or dangerous levels or rates of corrosion. Further corrosion investigation, corrective, or maintenance actions may be made based, at least in part, on the detected indicators of corrosion.

Several probing modalities using different physical measurements are available as the basis for corrosion monitoring. For example, an electrical resistance (ER) probe is a commonly used approach for online corrosion rate monitoring. Mass loss in the exposed metallic materials leads to an increase in electrical resistance. The exposed sensing element can be customized in material and shape for each specific application. ER probes work for both conductive media e.g., water or oil systems with a high water cut, and non-conductive environments e.g., oil and gas.

Electrochemical sensors leverage the intrinsic electrochemical characteristics of corrosion and utilize electrochemical techniques such as galvanic current measurement, linear polarization resistance (LPR), electrochemical impedance spectroscopy, and electrochemical noise. Advantages of electrochemical sensors include direct quantification of electrochemical corrosion rates and the capability of in-situ corrosion mechanism investigation with a variety of electrochemical techniques. LPR-based corrosion sensing is the most commercialized method among the electrochemical sensors because of relatively simple operation and data interpretation.

The magnetic flux leakage (MFL) method is a widely used nondestructive technology to detect anomalies in pipelines. The sensing principle is based on the magnetic properties of steels. When the ferromagnetic material is magnetized close to saturation under the applied magnetic field, the magnetic flux lines will mostly pass through the inside of the material when there are no defects, whereas the defect or corrosion sites will result in bending and leakage of magnetic flux lines. The magnetic field is usually generated by an electromagnet, and a Hall-effect sensor is used to detect the magnetic flux leakage. The MFL method is good for large area inspection but it is limited for the material surface and near surface detection. The ability of the method to determine the defect shapes and distinguish between internal and external defects.

Electromagnetic (EM)-based sensing provides another commonly used non-destructive corrosion monitoring technique. This method is based on the Faraday's law of induction with many variations available. One example is the multi-frequency EM inspection sensor to detect corrosion and pipeline integrity. The sensor consists of a transmitter coil and a receiver coil. The transmitter coil is excited by an alternating current, and the generated alternating magnetic field induces eddy currents in the surrounding conductive pipes. The primary EM field from the transmitter combined with a secondary field from eddy currents in the pipes induce a voltage in the separate receiver coil with a phase shift from the primary EM field. The phase shift and magnitude of change are related to the material electrical conductivity, magnetic permeability, and the presence of defects.

Ultrasonic thickness testing (UTT) wall thickness measurement is one of the most popular nondestructive methods to monitor corrosion and structural health of pipes. A piezoelectric transducer generates high frequency (MegaHertz) acoustic waves controlled through electric pulses, and these ultrasonic waves are emitted perpendicular to the pipe wall. The waves are bounced back by the external surface, inner surface, and geometric irregularities, which are received by the transducer. The sensor measures the time interval between the arrivals of reflected echoes from inner and outer surfaces to calculate the wall thickness. The wall thickness information combined with the stand-off signal can differentiate the internal and external mass-loss flaws along the pipe. UTT corrosion sensors have portable and fixed forms and can also be integrated with in-line inspection devices. The UTT method is capable of inspections with only one side accessible. The geometry resolution is related to the ultrasonic frequencies.

Irrespective of which probing modality is utilized, it is essential that repeated probing measurements are made at the same corrosion monitoring location (110) and orientation to a high degree of precision and reliability if the change in measurement value between repeats is to be effectively used to indicate the occurrence of corrosion. Traditional procedures for achieving repeatable and reliable identification of corrosion monitoring locations (110) include indicating these corrosion monitoring locations (110) on plant blueprints and marking the corrosion monitoring locations (110) with indelible markings, such as paint, ink, or less frequently stamping or engraving the plant components themselves. Unfortunately, blueprints can be misread or entail undue time to comprehend. Further, indelible marking may not be permanent, and may be damaged or erased or obscured by dirt. The documentation, recording and reporting of probe readings has traditionally performed manually on paper, or electronically via manually operated keyboard entry. Taken together, these practices can lead to error in identifying repeat corrosion monitoring location (110), and accidental or deliberate misassignment of probe values to incorrect corrosion monitoring locations (110). Consequently, a automated system that directs the operator of the test probe to the correct corrosion monitoring location (110) and orientation, only allows the recording of a probe measurement when the probe is in the correct corrosion monitoring location (110) and orientation, and automatically transmits the probe readings to a central recording system is desirable.

FIG. 1 further shows remote wireless beacons (112), in accordance with one or more embodiments. The remote wireless beacons (112) may be distributed at different locations around industrial plant. The remote wireless beacons (112) may emit a wireless signal that may be received by a portable corrosion monitoring device (200). The portable corrosion monitoring device (200) may determine its location base, at least in part, on the signal received from a plurality of remote wireless beacons (112). The remote wireless beacons (112) may further be in telecommunication with a central computer system. The telecommunication between the remote wireless beacons (112) and the central computer system (402) may be wireless telecommunication or may be performed using telecommunication cables.

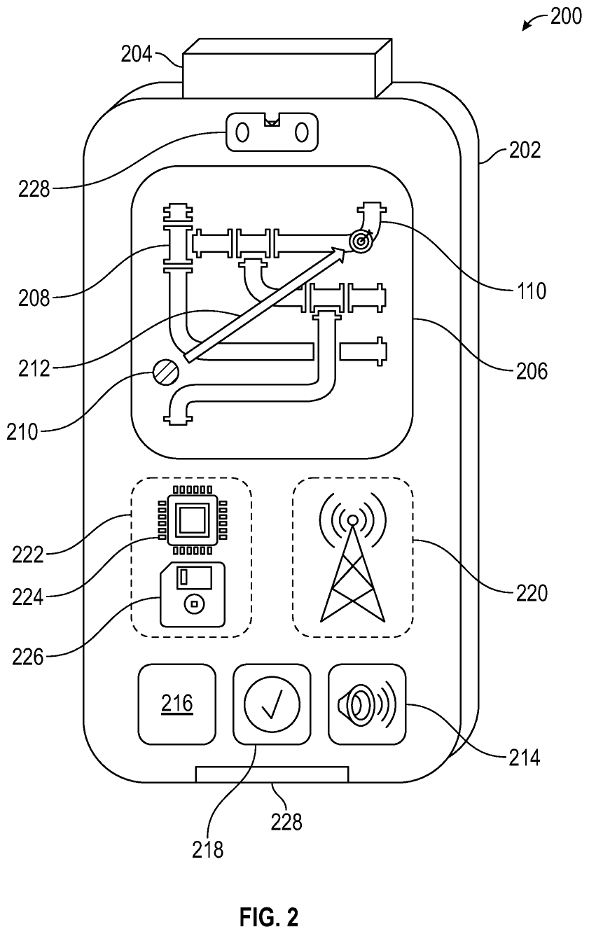

FIG. 2 shows a portable corrosion monitoring device (200), in accordance with one or more embodiments. The portable corrosion monitoring device (200) may have a device casing (202) that may be a handheld device casing (202) or may be designed to be worn suspended from an operator's neck. The portable corrosion monitoring device (200) may have a display screen (206) mounted on the device casing (202) that may show a representation (208) of the corrosion monitoring location (110). The corrosion monitoring location (110) may be displayed as a visual representation (208) such as a map or a diagram. Alternatively, the corrosion monitoring location (110) may be described on the display screen (206) using text, or as a combination of a visual representation and text.

In accordance with one or more embodiments, the display screen (206) may show the current location (210) of the portable corrosion monitoring device (200) in relation to the corrosion monitoring location (110). In addition, instructions for moving (212) the portable corrosion monitoring device (200) to the location of the corrosion monitoring location (110) may be displayed on the display screen (206) or may be provided to the user as a set of audible instructions conveyed via a loudspeaker (214). The display screen (206) and other functions of the portable corrosion monitoring device (200) may be controlled using one or more control buttons (216) mounted on the device casing (202). Further a dedicated measurement activation button (218) may be provided on the device casing (202) to initiate making one or more corrosion monitoring probe measurements.

The device casing (202) may further, in accordance with one or more embodiments contain a wireless transceiver (220). The wireless transceiver (220) may be configured to receive signals from the plurality of remote wireless beacons (112). The wireless transceiver (220) may be configured to transmit data to the remote wireless beacons (112). The data may include one or more corrosion monitoring probe measurements. The data may further include one or more of the locations orientations, and time at which the probe measurement is made. Furthermore, the data may be stored instead of, or as well as, wirelessly transmitted to the remote wireless beacons (112) in non-transitory computer memory (226) located within the device casing (202). The data may be downloaded from the non-transitory computer memory (226) to a computer system (not shown) at a later time via a data port (228) mounted on the device casing (202). The data port (228) may further function as a battery charging port to charge a rechargeable battery located within the portable corrosion monitoring device (200).

The device casing (202) may further contain an electronics module (222) containing instructions executable on a microprocessor (224) for determining, from the signals received from the plurality of remote wireless beacons (112), the current location (210) of the portable corrosion monitoring device (200). The electronics module (222) may further contain instructions executable on a microprocessor (224) for preventing the making of a corrosion monitoring probe measurement if the portable corrosion monitoring device (200) is not currently located at the predetermined corrosion monitoring location (110). Further, the instructions executable on a microprocessor (224) may prevent the making of a corrosion monitoring probe measurement if the portable corrosion monitoring device (200) is not oriented in the predetermined orientation required for making the corrosion monitoring probe measurement. The orientation of the portable corrosion monitoring device (200) may be determined by an orientation device (228), such as a gyroscope, mounted in the device casing (202).

In accordance with one or more embodiments, the corrosion monitoring probe (204) may be mounted on the device casing (202), as shown in FIG. 2. The corrosion monitoring probe (204) may be a UTT or may be an ER, LPR, MFL, or EM probe. In accordance with other embodiments, the corrosion monitoring probe (204) may consist of a combination of a plurality of these probes.

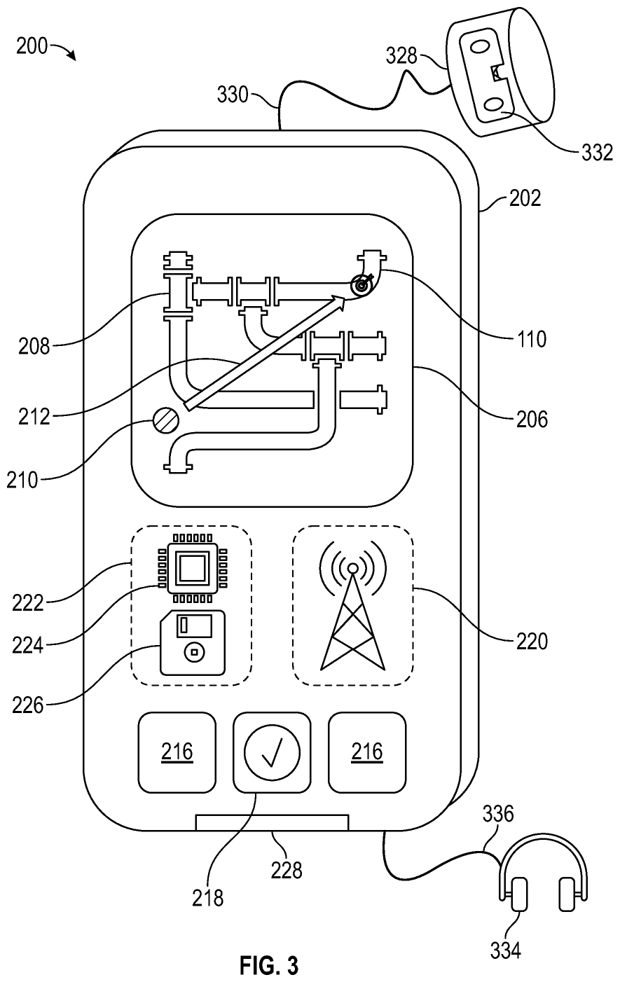

In accordance with one of more embodiments, the corrosion monitoring probe (328) may be a detached probe (328) connected to the device casing (202) by a flexible cable (330) to facilitate the making of corrosion monitoring probe measurements, as shown in FIG. 3. In this embodiment, the orientation sensor (332) may be mounted in the corrosion monitoring probe (328), rather than the device casing (202), to facilitate the accurate determination of the orientation of the detached probe (328).

In accordance with one or more embodiments, headphones (334) may be worn by the operator to receive instructions audible instructions from the portable corrosion monitoring device (200). The instructions may concern instructions for locating the corrosion monitoring probing locations. Headphones (334) may be a more effective means for conveying audible instructions than the loudspeaker (214) mounted in the device casing (202) especially in noisy environments. The headphones (334) may be communicatively connected to portable corrosion monitoring device (200) using a communications cable (336) or using wireless communication, such as a Bluetooth protocol. The headphones (334) and the detached probe may be used in combination with each other or either may be used alone without departing from the scope of the invention.

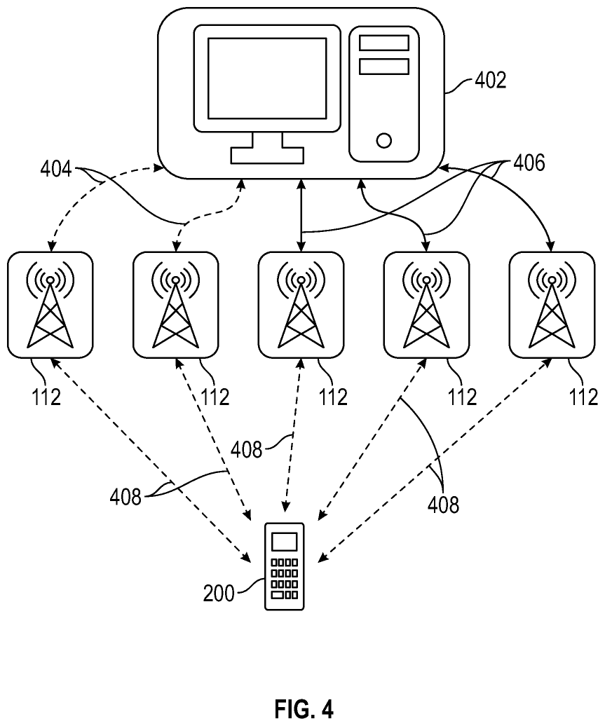

FIG. 4 shows a network, in accordance with one or more embodiments. The network may consist of a plurality of remote wireless beacons (112) distributed at a variety of locations around an industrial facility (100). Each remote wireless beacon (112) may be in telecommunication with a central computer system (402). The telecommunication may be performed using wireless connections (404) or using telecommunication cable (406).

In accordance with one or more embodiments, the portable corrosion monitoring device (200) may receive wireless signals (408) from a plurality of remote wireless beacons (112). The wireless signals (408) may be communicated using a WiFi standard, a Bluetooth standard, or a Bluetooth Low Energy (BLE) standard.

Further, in accordance with one or more embodiments, the portable corrosion monitor may transmit data to one or more remote wireless beacons (112) that may in turn relay the data to the computer system (402). The data may include one or more corrosion monitoring probe measurements together with information about the time, location, and orientation of the portable corrosion monitoring device (200) at which the probing measurement was made. Alternatively, the data may be stored in non-transitory computer memory (226) within the portable corrosion monitoring device (200) and download at a later time. In some embodiments the data may be transmitted to one or more remote wireless beacons (112) and stored in non-transitory computer memory (226) for later download.

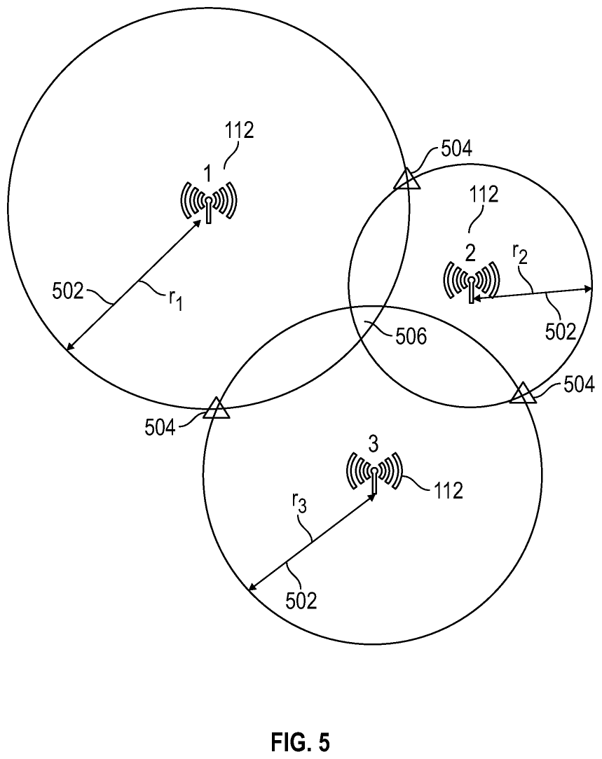

In accordance with one or more embodiments, the portable corrosion monitoring device (200) may determine its location based, at least in part, on the signals it receives from the remote wireless beacons (112). The portable corrosion monitoring device (200) may use a trilateration method to determine its location, as shown in FIG. 5.

Trilateration is a mathematical technique in which the location of a point in space is calculated using known distances (502) from the point to a series of known geometrical entities, e.g., a remote wireless beacon (112). In accordance with one or more embodiments, the point in space to be located is the location of the portable corrosion monitoring device (200). FIG. 5 illustrates the trilateration for three remote wireless beacons (112), enumerated 1, 2 and 3. The distances (502) from the portable corrosion monitoring device (200) to each of the three remote wireless beacons (112) are denoted rᵢ, i=1, 2, 3. In general, there may be more remote wireless beacons (112) than the three remote wireless beacons (112) depicted in FIG. 5. The distances (502) rᵢ may be determined based upon the strength of the received signal:

$${r}_{i} = {10}^{\frac{A - {RSSI}_{i}}{10 n}} \qquad Equation ( 1 )$$

where RSSIᵢ and is the received signal strength indicator value for the i-th remote wireless beacon (112), and A and n are constants which depend on the environment. A and n may be determined using a calibration procedure for a particular environment by recording the received signal strength indicator value at one or more calibration distances from the remote wireless beacon (112). RSSI is used by the BLE standard.

Alternatively, the distances (502), rᵢ, may be determined based upon the time of flight of the signal between the remote wireless beacon (112) and the location of the portable corrosion monitoring device (200).

The distance of the point to be located may be expressed in cartesian coordinates, (x, y, z), as:

rᵢ²=(x−xᵢ)²+(y−yᵢ)²+(z−zᵢ)² Equation (2)

where xᵢ, yᵢ, and zᵢ are the known cartesian coordinates of the i-th remote wireless beacon (112). If the portable corrosion monitoring device (200) receives signals from only two remote wireless beacons (112) there are in general two solutions for the location (504) of the portable corrosion monitoring device (200). These points are marked by triangles in FIG. 5. The only exception to this rule occurs if the portable corrosion monitoring device (200) lies exactly on a straight line connecting the two remote wireless beacons (112) from which signals are received. However, if wireless signals (408) are received by the portable corrosion monitoring device (200) from three or more remote wireless devices then, provided there is no error in the distances (502), rᵢ, the location of the portable corrosion monitoring device (200) may be a uniquely determined location (506).

In the more realistic case, some level of error is present in the measured RSSI value and consequently in the inferred distance rᵢ. In these circumstances equation (2) may be replaced by forming a cost function based, at least in part, on the difference between the distances of a trial location from each remote wireless sensor and the inferred distances obtained via the RSSI method. The optimum solution (506) for the location of the portable corrosion monitoring device (200) may then be obtained, in accordance with on or more embodiments, by minimizing this cost function. An uncertainty estimation for the location of the portable corrosion monitoring device (200) may also be obtained from the minimization of the cost function.

The location of the portable corrosion monitoring device (200) when determined using any method based upon determinations of its distance (502) from a plurality of remote wireless beacons (112) made at a single time may be subject to additional random errors. These random errors may cause location determinations, when view sequentially from one time to the next, to appear to vary erratically. To ameliorate this phenomenon the sequential location determinations of the portable corrosion monitoring device (200) may be filtered, in accordance with one or more embodiments. The filtering may be performed using a Kalman filter.

The Kalman filter uses multiple sequential measurements of location (506) and the uncertainty of each measurement to form an estimate of the location (506) that is better than the estimate obtained by using only one measurement alone. The Kalman filter deals effectively with the uncertainty due to noisy sensor data and, to some extent, with random external factors. The Kalman filter produces an estimate of the location (506) of the portable corrosion monitoring device (200) as an average of a predicted location of the portable corrosion monitoring device (200) and of the new measurement of the location of the portable corrosion monitoring device (200) using a weighted average. The purpose of the weights is to give greater significance a to location determined with low uncertainty than to a location determined with high uncertainty.

The result of the weighted average is a new location estimate that lies between the predicted and measured locations and has a better estimated uncertainty than either alone. This process is repeated for every new location estimate and its covariance informs the prediction used in the following iteration. This means that Kalman filter works recursively and requires only the last best estimate of the location, rather than the entire history, of the locations of the portable corrosion monitoring device (200) to calculate a new location.

The relative certainty of the measurements and current estimate of the location (506) of the portable corrosion monitoring device (200) is an important consideration, and it is common to discuss the response of the filter in terms of the Kalman filter's gain. The Kalman gain is the relative weight given to the prior determinations of the location of the device monitor and the current estimate. The gain can be tuned, by varying the weights, to achieve a particular performance. With a high gain, the filter places more weight on the most recent measurements, and thus follows them more responsively. With a low gain, the filter follows the model predictions more closely. At the extremes, a gain close to one will result in a more erratic estimated location trajectory, while a gain close to zero will smooth out noise but decrease the responsiveness.

In accordance with one or more embodiments, the accuracy of the location determinations may be enhanced by integrating addition sensors into the portable corrosion monitoring device (200). In some embodiments, an accelerometer may record the acceleration of the portable corrosion monitoring device (200). The accelerations which may be double integrated over time to provide a trajectory of the portable corrosion monitoring device (200) in three-dimensional space with time. In other embodiments, the portable corrosion monitoring device (200) may include a barometer that may record the barometric pressure experienced by the portable corrosion monitoring device (200). The barometric pressure may provide the elevation of the device.

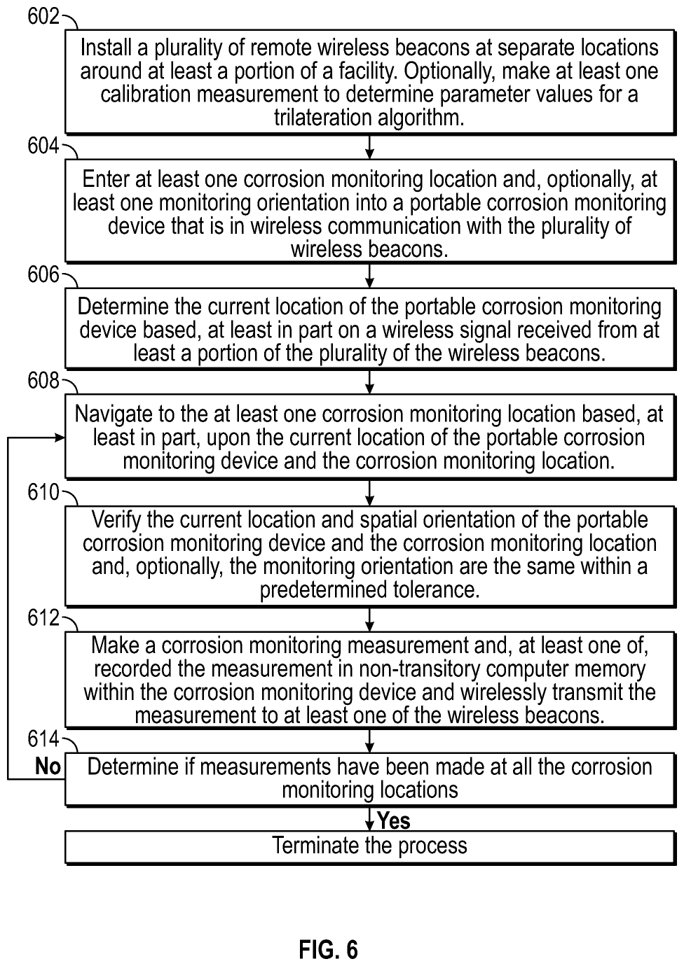

FIG. 6 shows a flowchart for a corrosion monitoring program, in accordance with one or more embodiments. In Step 602 a plurality of remote wireless beacons (112) may be installed at separate locations around at least a portion of a facility (100). Further, in Step 612 at least one calibration measurement may be made to determine one or more parameter values to be used in a trilateration algorithm.

In Step 604 at least one corrosion monitoring location (110) and, optionally, at least one corrosion monitoring orientation may be entered into a portable corrosion monitoring device (200). The entering may be performed manually or may be performed by uploading data to the portable corrosion monitoring device (200) from a computer system (402). The uploading may be performed wirelessly or may be performed via the data port (228).

Steps 602 and 604 may be performed only once at the beginning of a corrosion monitoring program, while later steps may be performed repeatedly at predetermined or data-driven intervals.

In Step 606, the current location (506) of the portable corrosion monitoring device (200) may be determined based, at least in part on a wireless signal received from at least a portion of the plurality of the remote wireless beacons (118) located at various locations around the facility (100). The wireless signals (408) may be transmitted and received using the Bluetooth Low Energy standard. The determination of the current location of the portable corrosion monitoring device (200) may be performed using a trilateration algorithm, which may be enhanced with at least one Kalman filter.

In Step 608, in accordance with one or more embodiments, the operator may navigate to the at least one corrosion monitoring location (110) based, at least in part, on directional instructions provided by the portable corrosion monitoring device (200). The directional instructions may be based, at least in part, on the current location of the portable corrosion monitoring device (200) and the corrosion monitoring location (110). The directional instructions may be communicated to the operator visually via a display screen (206) mounted on the device casing (202) of the portable corrosion monitoring device (200) or audibly via a loudspeaker (214) mounted on the device casing (202) of the portable corrosion monitoring device (200) or via headphones (334) attached the portable corrosion monitoring device (200) by either a telecommunications cable or wirelessly.

In Step 610, the portable corrosion monitoring device (200) may verify that current location and, optionally, the spatial orientation of the portable corrosion monitoring device (200) and the corrosion monitoring location (110) and, optionally, the monitoring orientation are coincident within a predetermined tolerance. In accordance with one or more embodiments, the portable corrosion monitoring device (200) will only permit a corrosion monitoring probe measurement to be made when the current location (506) and, optionally, current orientation of the portable corrosion monitoring device (200) and the corrosion monitoring location (110) and, optionally, corrosion monitoring orientation are coincident.

In Step 612 a corrosion monitoring probe measurement may be made. Further, the probe measurement may be recorded in non-transitory computer memory (226) within the portable corrosion monitoring device (200). The probe measurement may be stored together with data on the location (506) and, optionally, orientation of the portable corrosion monitoring device (200) at the time the probe measurement was made. In accordance with some embodiments, the corrosion monitoring probe measurement, optionally, together with at least one of the location (506) and orientation of the portable corrosion monitoring device (200) and the time at which the measurement was made, may be transmitted to at least one of the remote wireless beacons (112) and thence to a central computer system (402). In accordance with other measurements, the corrosion monitoring probe measurement and, optionally, associated location, orientation and timing data, may be downloaded to the computer system (402) via a data port (228) at a later time. The corrosion monitoring probe measurement and, optionally, associated location, orientation and timing data may be both stored in the portable corrosion monitoring device (200) and later downloaded to the computer system (402), and transmitted wirelessly via the remote wireless beacons (112).

In Step 614, the instructions executable on a microprocessor (224) in the electronics module (222) of the portable corrosion monitoring device (200) may determine if corrosion probe measurements have been made at all the corrosion monitoring locations (110). If probe measurements have been made at every location the process may be terminated. If probe measurements have not been made at every location the process may return to Step 608 and the operator may navigate to the next corrosion monitoring location (110).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

1. A portable corrosion monitoring device, comprising:
at least one corrosion monitoring sensor comprising an ultrasonic thickness sensor;
a motion sensor comprising at least one accelerometer to track motion of the portable corrosion monitoring device;
a wireless transceiver configured to receive signals from a plurality of remote wireless beacons;
a microprocessor configured to determine a spatial position of the portable corrosion monitoring device based, at least in part, on the signals received from the plurality of remote wireless beacons, and
a visual display and audio outputs, which are used by the microprocessor to communicate audio/visual instructions to an operator of the portable corrosion monitoring device based on the tracked motion of the portable corrosion monitoring device,
wherein the audio/visual instructions represent a position for the operator to perform corrosion monitoring, and
wherein the corrosion monitoring sensor makes a corrosion monitoring measurement using the ultrasonic thickness sensor only when the corrosion monitoring device is in a predetermined spatial position.

2. The portable corrosion monitoring device of claim 1, further comprising:
an orientation device for determining the spatial orientation of the corrosion monitoring sensor.

3. (canceled)

4. The portable corrosion monitoring device of claim 1, wherein the wireless transceiver uses a Bluetooth Low Energy protocol.

5. (canceled)

6. The portable corrosion monitoring device of claim 1, wherein the visual display is configured to communicate instructions for changing the spatial position and spatial orientation of the portable corrosion monitoring device from the microprocessor to the operator.

7. The portable corrosion monitoring device of claim 2, wherein the microprocessor contains instructions executable by the microprocessor to prevent recording of a measurement by the corrosion monitoring except when the portable device is in at least one of a predetermined spatial position and a predetermined spatial orientation.

8. The portable corrosion monitoring device of claim 1, wherein the wireless transceiver is further configured to transmit a corrosion monitoring measurement to at least one of the plurality of remote wireless beacons.

9. The portable corrosion monitoring device of claim 1, further comprising a non-transitory memory for storing at least one of a spatial position of the portable corrosion monitoring device and a spatial orientation of the portable corrosion monitoring device.

10. A portable corrosion monitoring system, comprising:
a plurality of remote wireless beacons located at a plurality of different spatial locations;
at least one corrosion monitoring device configured to wirelessly exchange a signal with the plurality of remote wireless beacons and comprising:
at least one corrosion monitoring sensor comprising an ultrasonic thickness sensor;
a motion sensor comprising at least one accelerometer to track motion of the portable corrosion monitoring device;
a microprocessor configured to determine a spatial position of the portable corrosion monitoring device based, at least in part, on the signals received from the plurality of remote wireless beacons,
a visual display and audio outputs, which are used by the microprocessor to communicate audio/visual instructions to an operator of the portable corrosion monitoring device based on the tracked motion of the portable corrosion monitoring device,
wherein the audio/visual instructions represent a position for the operator to perform corrosion monitoring, and
wherein the corrosion monitoring sensor makes a corrosion monitoring measurement using the ultrasonic thickness sensor only when the corrosion monitoring device is in a predetermined spatial position; and
a computer system configured to receive and process corrosion monitoring measurements made by the corrosion monitoring device.

11. The portable corrosion monitoring system, of claim 10, wherein the corrosion monitoring device is further configured to make a sample thickness determination.

12. The portable corrosion monitoring system, of claim 10, wherein the computer system is connected to the remote wireless beacons and is configured to receive the corrosion monitoring measurement from the remote wireless beacons.

13. The portable corrosion monitoring system, of claim 10, wherein the computer system is configured to receive the corrosion monitoring measurement directly from the portable corrosion monitoring device after a corrosion monitoring campaign.

14. The portable corrosion monitoring system, of claim 10, wherein the computer system is configured to determine if a current corrosion monitoring measurement made at a predetermined corrosion monitoring location differs from at least one previous corrosion monitoring measurement made at the predetermined corrosion monitoring location by at least a predetermined value.

15. A method of corrosion monitoring, comprising:
installing a plurality of wireless beacons at a plurality of different spatial locations configured to wirelessly communicate with a portable corrosion monitoring device,
wherein the corrosion monitoring device comprises:
at least one corrosion monitoring sensor comprising an ultrasonic thickness sensor;
a motion sensor comprising at least one accelerometer to track motion of the portable corrosion monitoring device;
a microprocessor configured to determine a spatial position of the portable corrosion monitoring device based, at least in part, on the signals received from the plurality of remote wireless beacons,
a visual display and audio outputs, which are used by the microprocessor to communicate audio/visual instructions to an operator of the portable corrosion monitoring device based on the tracked motion of the portable corrosion monitoring device,
wherein the audio/visual instructions represent a position for the operator to perform corrosion monitoring, and
wherein the corrosion monitoring sensor makes a corrosion monitoring measurement using the ultrasonic thickness sensor only when the corrosion monitoring device is in a predetermined spatial position;
entering coordinates of at least one predetermined corrosion monitoring location into a portable corrosion monitoring device that is in wireless communication with the plurality of remote wireless beacons;
determining a current position of the portable corrosion monitoring device based, at least in part, on a wireless signal received from at least a portion of the plurality of the remote wireless beacons;
communicating instructions to an operator of the portable corrosion monitoring device based on the motion of the portable corrosion monitoring device;
positioning the portable corrosion monitoring device at the predetermined corrosion monitoring location; and
performing a corrosion monitoring measurement of a sample using the ultrasonic thickness sensor only when the corrosion monitoring device is in at least one of a predetermined spatial position or spatial orientation.

16. The method of corrosion monitoring of claim 15, wherein positioning the portable corrosion monitoring device at a predetermined corrosion monitoring location, comprises reading a visual display indicating a position of a predetermined corrosion monitoring location and a current position of the portable corrosion monitoring device and moving the portable corrosion monitoring device to cause the current position to become coincident with the predetermined position to within a predetermined tolerance.

17. The method of corrosion monitoring of claim 15, wherein positioning the portable corrosion monitoring device at a predetermined corrosion monitoring location, further comprises spatially orienting the portable corrosion monitoring device at a predetermined spatial orientation.

18. The method of corrosion monitoring of claim 15, wherein performing a corrosion monitoring measurement comprises measuring sample thickness determination and, at least one of, storing a measurement in a non-transitory computer memory in the corrosion monitoring device and wirelessly transmitting a measurement to the remote wireless beacons.

19. The method of corrosion monitoring of claim 18, wherein a measurement comprises a sample thickness determination and a portable corrosion monitoring device location at which the sample thickness was determined.

20. The method of corrosion monitoring of claim 15, wherein performing a corrosion monitoring measurement further comprises determining if a current corrosion monitoring measurement made at the predetermined corrosion monitoring location differs from at least one previous corrosion monitoring measurement made at the predetermined corrosion monitoring location by at least a predetermined value.
